(19) United States
(12) Patent Application Publication
(10) Pub. No.: US 2025/0164244 A1
(43) Pub. Date: May 22, 2025

(54) ADJUSTABLE BUBBLE LEVEL TOOL

(71) Applicant: Patrick James BROWN, St. Louis, MO (US)

(72) Inventor: Patrick James BROWN, St. Louis, MO (US)

(21) Appl. No.: 18/932,904

(22) Filed: Oct. 31, 2024

Related U.S. Application Data
(60) Provisional application No. 63/599,647, filed on Nov. 16, 2023.

(51) Int. Cl. G01C 9/34; G01C 9/28; G01C 9/32

(52) U.S. Cl. CPC G01C 9/34; G01C 9/28; G01C 9/32

(57) ABSTRACT

A level tool for use in bending electrical wiring conduits comprises a frame, a carrier coupled to the frame and rotatable relative to the frame through an angular range, and a bubble level carried by and rotatable with the carrier through the angular range. The frame includes a first face plate, a second face plate, and a spacer between the first and second face plates, wherein the spacer includes an open mouth arranged to allow a user to view the bubble level from above and from a side of the level tool. The first and/or second face plates may have a bubble window to enable viewing of the bubble level from the front and/or rear of the level tool and an indexing slot cooperating with an indexing element on the carrier for selectively setting a rotational angle of the bubble level at one of several predetermined angular settings.

### FIELD

The present disclosure relates to tools for indicating an angle of inclination of a surface or structural element relative to horizontal.

### BACKGROUND

Current practice in bending conduits such as those used to channel electrical wiring is to use bubble levels common to the carpentry trade, or an angle protractor having a side-view dial that indicates the incline angle of a reference edge of the protractor. Typically the conduit is placed in a bending tool, which is then placed on the floor and the bending process begins. The person bending the conduit is looking down on the conduit as the bend is being formed. In the context of bending conduits for electrical wiring, bubble levels used in the carpentry trade do not facilitate determination that a desired bend angle between one portion of a conduit and another portion of the conduit is achieved if the angle is other than 90°, and require that the person forming the bend stop the bending process to check the angle by viewing the bubble level from the side. Angle protractors allow more bend angles to be checked, but again the person bending the conduit must stop the bending process to check the bend angle by viewing the protractor from the side. Therefore, the bending process using current tools is inefficient and leads to errors.

### OBJECT

An object of the present disclosure is to provide a compact bubble level tool for electrical wiring professionals that is suitable for quickly and easily checking whether a desired conduit bend angle is achieved while the bending process is taking place without the need to pause and change viewing direction.

### BRIEF SUMMARY

A level tool according to an embodiment of the present disclosure generally comprises a frame, a carrier coupled to the frame and rotatable relative to frame about a rotational axis through an angular range, and a bubble level carried by the carrier for rotation with the carrier relative to the frame about the rotational axis through the angular range. The frame may include a first face plate, a second face plate, and a spacer between the first and second face plates, wherein the spacer includes an open mouth arranged to allow a user to view the bubble level from above the level tool and from a side of the level tool. At least one of the first and second face plates has a bubble window, wherein the bubble window is configured to enable viewing of the bubble level at all angular positions of the bubble level through the rotational range. At least one of the first and second face plates may have an indexing slot and the carrier may include an indexing element received by the indexing slot for engagement with a selected one of a plurality of angle-setting detents respectively defining a plurality of predetermined angular settings. The level tool may further comprising a magnet arranged for magnetically attracting the level tool to a ferrous structure such as a metal conduit.

### BRIEF DESCRIPTION OF THE SEVERAL VIEWS OF THE DRAWINGS

FIG. 1 is a perspective view of a conduit level formed in accordance with an embodiment of the present disclosure;

FIG. 2 is a front elevational view of the conduit level shown in FIG. 1, wherein the conduit level is at a first angle setting thereof;

FIG. 3 is a view similar to that of FIG. 2, wherein the conduit level is at a second angle setting thereof;

FIG. 4 is a side elevational view of the of the conduit level shown in FIG. 1;

FIG. 5 is a cross-sectional view of the conduit level taken generally along the line A-A in FIG. 4;

FIG. 6 is a cross-sectional view of the conduit level taken generally along the line B-B in FIG. 5;

FIG. 7 is a cross-sectional view showing a frame of the conduit level;

FIG. 8 is a front view of a rotatable carrier of the conduit level;

FIG. 9 is a view similar to that of FIG. 5, wherein a carrier and a bubble level of the conduit level are rotated by 90° relative to the view of FIG. 5;

FIG. 10 is a top plan view of the conduit level shown in FIG. 1; and

FIG. 11 is a bottom plan view of the conduit level shown in FIG. 1.

### DETAILED DESCRIPTION

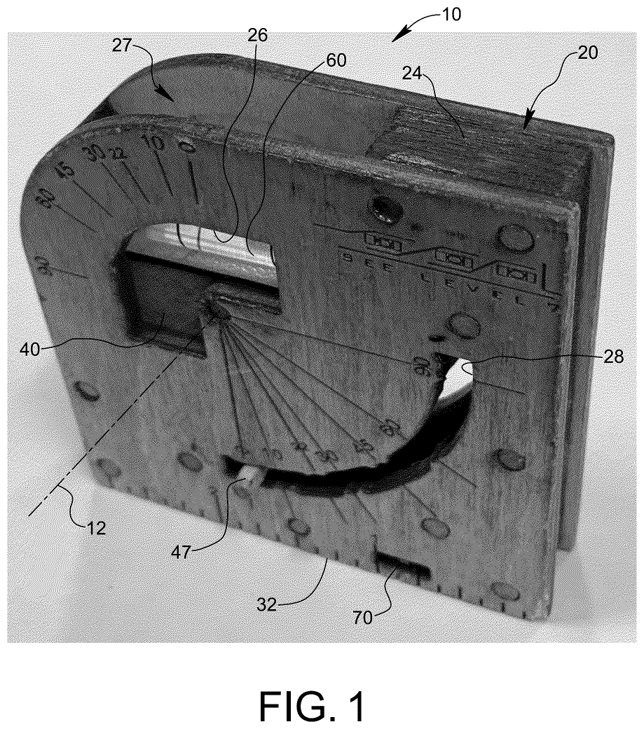

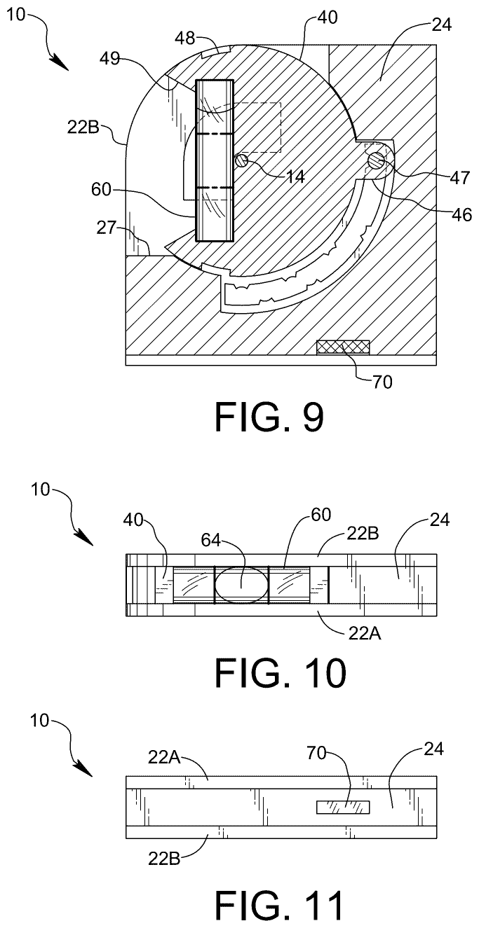

Referring to FIGS. 1 through 11, a conduit level 10 of the present disclosure generally comprises a frame 20, a carrier 40 rotatable relative to frame 20 about a rotational axis 12, and a bubble level 60 carried by carrier 40 for rotation with the carrier. In the disclosed embodiment, carrier 40 is rotatably coupled to frame 20 by a cylindrical pivot pin 14 to define pivot axis 12. Bubble level 10 may also comprise one or more magnets 70 for magnetically attracting conduit level 10 to a ferrous conduit or other ferrous structure.

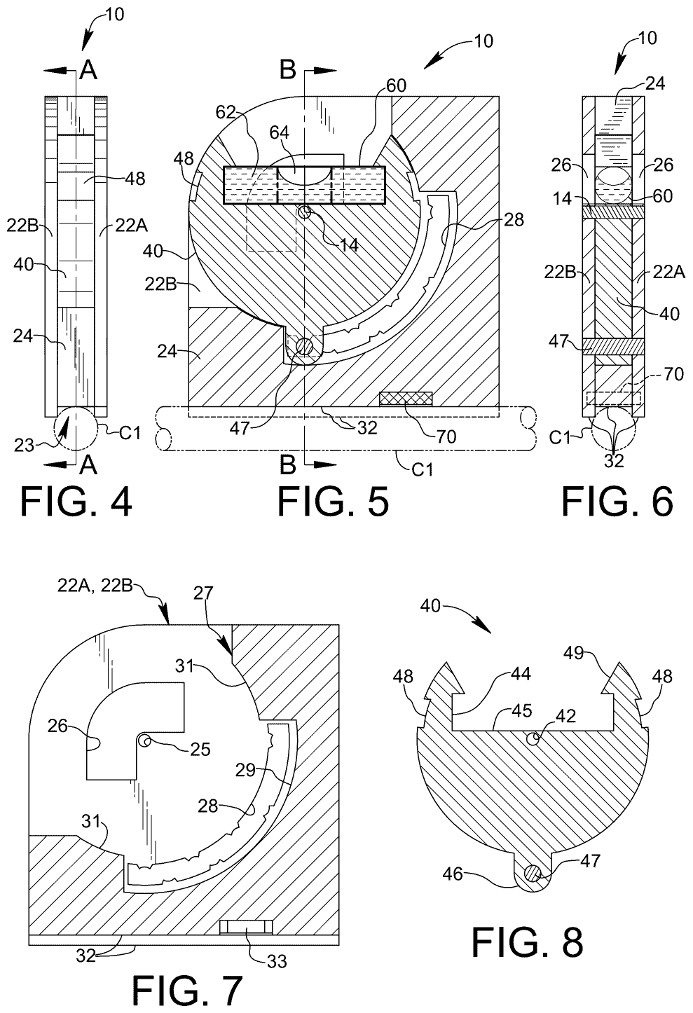

Frame 20 may include first face plate 22A, a second face plate 22B, and a spacer 24 sandwiched between first and second face plates 22A, 22B. Each face plate 22A, 22B may have a pivot hole 25 for receiving an end of pivot pin 14, a bubble window 26, an indexing slot 28, a plurality of angle-setting detents 30 along indexing slot 28, a reference edge 32, and a rounded corner 34. Frame 20 may also include angle-setting indicia 36 associated with angle-setting detents 30 and length indicia 37 associated with reference edge 32. Face plates 22A, 22B may extend beyond the bottom surface or edge of spacer 24, as shown in FIG. 4, to define a channel 23 extending along reference edge 32 for straddling a cylindrical wiring conduit segment C1. As used herein, the term “reference edge” may refer to an edge, a flat surface, or a cross-sectional shape such as a channel or other shape that extends in a straight reference direction relative to which a longitudinal axis of bubble level 60 may be pivotally adjusted to a desired angular setting. In one embodiment, channel 23 has a width of approximately 0.375 inches (9.525 mm).

As may be seen in the illustrated embodiment, each bubble window 26 may have a right-angle shape folding around the location of pivot pin 14 that is configured to enable viewing of bubble level 60 through a range of angular settings described further below. Indexing slot 28 may be an arcuate slot proceeding through an angle of slightly more than 90° about pivot axis 12 on an opposite side of pivot pin 14 relative to where bubble window 26 folds.

Spacer 24 may include an open region or mouth 27 for accommodating rotatable carrier 40 through its range of rotational settings relative to frame 20. As seen in FIG. 7, mouth 27 may have an arcuate indexing recess 29 at its inner end and arcuate carrier guide surfaces 31 adjacent opposite ends of indexing recess 29. Mouth 27 may open outward along upper and side edges of frame 20 connected by rounded corner 34 to allow a user to view bubble level 60 from above conduit level 10 and from a side of conduit level 10. Spacer 24 may further include a magnet seat 33 near reference edge 32 for receiving magnet 70.

An embodiment of carrier 40 is shown in isolation in FIG. 8. Carrier 40 may be a disc having a thickness the same as or slightly less than a thickness of spacer 24. Carrier 24 maybe be supported between first and second face plates 22A, 22B by pivot pin 14 for rotation about pivot axis 12 relative to frame 20. Carrier 40 may have a generally semicircular shape characterized by a mounting hole 42 through which pivot pin 14 is received, a bubble level receptacle 44 sized to receive and frictionally hold bubble level 60, an indexing tab 46 protruding radially from the semicircular portion of carrier 40, and an indexing element 47 arranged to extend through a hole in indexing tab 46. Bubble level receptacle 44 may be configured and arranged to position bubble level 60 such that the bubble level extends longitudinally along a chord offset from mounting hole 42, and indexing tab 46 with indexing element 47 may be aligned along a diametral line extending though a center of mounting hole 42 and extending perpendicular to reference edge 32 and the longitudinal direction of the bubble level 60. A radially inner backing surface 45 of bubble level receptacle 44 may be coated or colored to provide a white, off-white, or bright color contrast surface for easier viewing of bubble level 60 situated against backing surface 45. Carrier 40 may include one or more grip recesses 48 along a periphery of carrier 40 for finger engagement by a user to facilitate manual rotation of carrier 40 relative to frame 20. For example, as shown in FIG. 8, a pair of grip recesses 48 may be aligned with opposite ends of bubble level 60. Carrier 40 may have an open region 49 through its periphery that aligns with mouth 27 of spacer 24 in all rotational positions of carrier 40 to enable bubble level 60 to be viewed regardless of the angular adjustment position at which carrier 40 and bubble level 60 are set.

Bubble level 60 may be a cylindrical bubble level containing liquid 62 and a gas bubble 64 that migrates under gravity to a top center position in the bubble level housing, as is familiar in the art of levels and leveling tools.

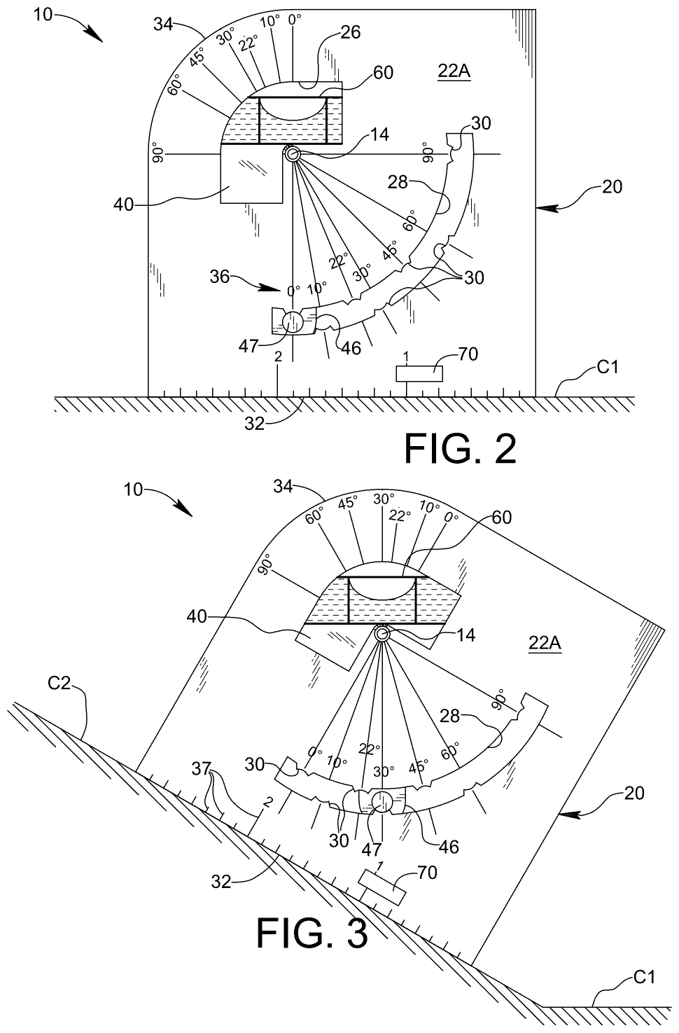

As may be understood with reference to FIGS. 2 and 3, carrier 40 may be rotated manually about pivot axis 12 to any of a plurality of predetermined angular settings defined by detents 30. When indexing element 47 on tab 46 aligns with a detent 30 on each of first and second face plates 22A, 22B, the detents 30 releasably hold indexing element 47 to maintain carrier 40 and bubble level 60 at an angular setting corresponding to the particular detent 30. In FIG. 2, indexing element 47 on tab 46 is captured by the 0° setting detents 30 on face plates 22A, 22B (only one detent 30 being visible in FIG. 2) such that bubble level 60 extends parallel to reference edge 32. When a user wants to install a conduit segment C1 having a 0° incline (horizontal), conduit level 10 may be used at the 0° setting and reference edge 32 may be positioned along conduit segment C1 to confirm proper levelling. In FIG. 3, indexing element 47 on tab 46 is captured by the 30° setting detents 30 on face plates 22A, 22B (only one detent 30 being visible in FIG. 3) such that bubble level 60 extends at a 30° angle relative to reference edge 32. As may be seen, the orientation of bubble level 60 is adjusted by carrier 40 so that the bubble level 60 extends horizontally when a particular angle setting is chosen and reference edge 32 is placed flush with the surface of a conduit segment having the chosen angular incline. When a user wants to bend a conduit segment C2 at a 30° incline relative to conduit segment C1, conduit level 10 may be set at 30° and mounted on conduit segment C2 with reference edge 32 positioned along conduit segment C2 while the conduit bend is being formed, whereby the user can view bubble level 60 from above through mouth 27 and open region 49 as the bend is being formed and can stop when the bubble 64 is centered in bubble level 60 to confirm proper levelling. The pause-free process improves efficiency and reduces errors.

In the disclosed embodiment, detents 30 are provided along the indexing slot 28 of each face plate 22A, 22B to define angular settings at 0°, 10°, 22.5°, 30°, 45°, 60°, and 90°. These angles are chosen for their common usage in the field. Those skilled in the art will recognize that other angular settings may be provided. Detents 30 may be arranged in alternating fashion along the radially inner and radially outer edges of indexing slots 28 for spatially accommodating the detents 30 at desired angular settings.

Conduit level 10 may be sized to fit in a work shirt chest pocket. This is a most convenient way to carry the conduit level as compared to levels now in use. For example, reference edge 32 may be three inches in length.

As will be understood from the foregoing, the angle indicating element (bubble level 60) of conduit level 10 is visible from above throughout the bending process, which is not possible using known levels and protractors. The person using the bending tool can see the progress and will know when the desired bend angle is achieved without interrupting the bending process.

What is claimed is:

1. A level tool (10) comprising:
a frame (20);
a carrier (40) coupled to the frame and rotatable relative to frame (20) about a rotational axis (12) through an angular range; and
a bubble level (60) carried by the carrier (40) for rotation with the carrier relative to the frame about the rotational axis through the angular range.

2. The level tool according to claim 1, wherein the frame includes a first face plate (22A), a second face plate (22B), and a spacer (24) between the first and second face plates.

3. The level tool according to claim 2, wherein the spacer includes an open mouth (27) arranged to allow a user to view the bubble level from above the level tool and from a side of the level tool.

4. The level tool according to claim 3, wherein the frame includes a rounded corner (34) registering with the mouth.

5. The level tool according to claim 2, wherein at least one of the first and second face plates has a bubble window (26), wherein the bubble window is configured to enable viewing of the bubble level at all angular positions of the bubble level through the rotational range.

6. The level tool according to claim 5, wherein the angular range is 0° through 90°.

7. The level tool according to claim 2, wherein at least one of the first and second face plates has an indexing slot (28) and the carrier includes an indexing element (47) received by the indexing slot.

8. The level tool according to claim 7, wherein the indexing slot includes a plurality of angle-setting detents (30) respectively defining a plurality of predetermined angular settings, and the indexing element is releasably held by a selected one of the plurality of angle-setting detents to maintain the carrier and the bubble level at a selected predetermined angular setting defined by the selected one of the plurality of angle-setting detents.

9. The level tool according to claim 1, wherein the carrier includes one or more grip recesses (48) along a periphery of the carrier for finger engagement by a user to facilitate manual rotation of the carrier relative to the frame.

10. The level tool according to claim 1, further comprising a magnet (70) arranged for magnetically attracting the level tool to a ferrous structure.

11. The level tool according to claim 9, wherein the frame includes a reference edge (32) and the spacer includes a magnet seat (33) near the reference edge, wherein the magnet is received in the magnet seat.
